(19) United States
(12) Patent Application Publication
(10) Pub. No.: US 2004/0197180 A1
(43) Pub. Date: Oct. 7, 2004

(54) Fall protected test-head manipulator

(76) Inventors: Earl William Sausen, Gilroy, CA (US); Robert H. Aochi, Morgan Hill, CA (US)

Correspondence Address: Robert Charles Hill, 235 Montgomery Street #821, San Francisco, CA, 94104, US

(21) Appl. No.: 10/357,603

(22) Filed: Feb. 4, 2003

(51) Int. Cl. B65G 1/00

(52) U.S. Cl. 414/673

(57) ABSTRACT

A test manipulator comprises a floor stand with a vertical column to support the weight of a test head. The vertical column includes a shaft along which a cradle assembly for the test head can be slid up and down, pivoted, and twisted. A tool balancer is connected to the cradle assembly and provides for weightlessness by counterbalancing. A fall arrester is independently connected to the cradle assembly to allow slow unimpeded movements of the cradle assembly up-and-down, and to automatically lock-up to prevent a sudden fall of the cradle assembly. Releasing the load prevented from falling will reset the fall arrestor.

### FIELD OF THE INVENTION

The present invention relates to test manipulators, and more specifically to safety improvements in automatic test equipment (ATE) manipulators that prevent personal injury and equipment damage in the event of a serious failure of the counterbalancing mechanism.

### BACKGROUND OF THE INVENTION

Special device handlers are used in automatic testing of integrated circuits (IC) and other electronic devices to position a test head so a device-under-test (DUT) can be electrically probed and temperature cycled. Conventional test heads are now very heavy, on the order of several hundred pounds, because so much circuitry, cabling, and piping needs to be brought up close to the DUT.

Test handlers and manipulators have been developed by several commercial companies to make the test heads essentially weightless, and easy to manipulate, e.g., with six degrees of freedom. Such companies include Reid-Ashman (St. George, Utah), Advantest (Tokyo, Japan), Agilent Technologies (Palo Alto, Calif.), Credence Systems Corporation (Fremont, Calif.), Eagle Test Systems (Mundelein, Ill. ), LTX Corporation (Westwood, Mass.), SZ-Testsysteme (Germany), Easy Motion Technologies (Rosenheim, Germany), and Teradyne (Boston, Mass.).

Nathan Smith describes an early electronic test head positioner for a device handler in U.S. Pat. No. 4,588,346, issued May 13, 1986. Such can be used to hold and position ATE test heads for use with probers and handlers. A short floor stand with a main column allows a positioner assembly to glide up and down weightlessly with the help of a counterbalancing mechanism. A sliding pivot on a smooth round vertical shaft attaches to the positioner assembly, and is hoisted up by a cable that threads up through a top pulley. Down the other side of the pulley, the cable is attached to several bar-type counter-weights. Some experimentation is needed to find the correct set of counter-weights to add to exactly counter-balance the test head and positioner assembly. However, the counter-balancing mechanism is simple and effective, albeit heavy.

The suspension mechanisms used allow the test heads to be pushed up and down, twisted, and turned by the test operator on the test floor. The heavy weight of the test heads and the fact that the test head positioners allow them to be maneuvered at some height over the work floor in close proximity to workers, creates a safety concern. Tipping over is one concern, and so is a sudden failure of the counter-balancing mechanisms which can lead to several hundred pounds of concentrated weight being dropped. As can be expected, various governments and safety institutions have stepped-in to monitor and control the kinds of risks that workers are exposed to with such test manipulators.

Alyn Holt, et al, describes a safety lock for such a materials handling system in U.S. Pat. No. 4,715,574, issued Dec. 29, 1987. A system for manipulating and positioning electronic test head loads is discussed that included a lock to set the vertical height of the manipulator after it is positioned. The trouble with this is said to be the consequences of suddenly releasing the lock if the test head is not then being exactly counterbalanced. The solution proposed was to prevent unlocking in the event the counterbalancing is in error by some margin. But such only compounds the difficulty in using such a manipulator because the operator must troubleshoot the reason the lock will not release.

Motorized, lead screw, cabled, and spring loaded counterbalancing systems are all used in test manipulators. The motors and lead screws can generate particles in clean rooms that are objectionable, so some applications must avoid using these kinds of mechanisms. Cables and springs wear and break, especially because they receive so much use in operation. The cables and springs are a weak link that can cause the sudden drop of the test head and injure an operator.

Counterweights can be more reliable than springs because simple gravity is used, but counterweights are heavy and add a lot of weight to an already heavy manipulator and its load. Cables are still needed to connect the counterweights, so these cables are a common culprit in weight suspension failures.

As device testing has developed to handle ever more increasingly complex tasks, the test heads themselves have gotten larger and heavier. The latest manipulators have had to grow in capability as a result. Safe, fully balanced systems have thus been more difficult to design.

### SUMMARY OF THE INVENTION

An object of the present invention is to provide a test manipulator that is safe to use near test operators.

Another object of the present invention is to provide a method for manipulating suspended weights.

A further object of the present invention is to provide a manipulator system that is simple and inexpensive to manufacture.

Briefly, a test manipulator embodiment of the present invention comprises a floor stand with a vertical column to support the weight of a test head. The vertical column includes a shaft along which a cradle assembly for the test head can be slid up and down, pivoted, and twisted. A tool balancer is connected to the cradle assembly and provides for weightlessness by counterbalancing. A fall arrester is independently connected to the cradle assembly to allow slow unimpeded movements of the cradle assembly up-and-down, and to automatically lock-up to prevent a sudden fall of the cradle assembly. Releasing the load prevented from falling will reset the fall arrestor.

An advantage of the present invention is that a manipulator that uses commercially available tool balancers and fall arrestors provides for test operator safety in the event of a mechanical failure of the counterbalancing.

Another advantage of the present invention is that a manipulator is provided that is easy to use.

A further advantage of the present invention is that a manipulator is provided that does not have to have the fall arrestor rebuilt or replaced in the event that it had to act to prevent a drop of the cradle assembly.

A still further advantage of the present invention is that a manipulator is provided that is relatively light in weight.

These and other objects and advantages of the present invention will no doubt become obvious to those of ordinary skill in the art after having read the following detailed description of the preferred embodiment as illustrated in the drawing figures.

### DESCRIPTION OF THE DRAWINGS

FIG. 1A is a backside view diagram of a test manipulator embodiment of the present invention;

FIG. 1B is a side view diagram of the test manipulator of FIG. 1A;

FIG. 2 is a functional block diagram of simplified test manipulator embodiments of the present invention of FIGS. 1A and 1B; and

FIG. 3 is a drop-preventing load balancer embodiment of the present invention in a more generalized form than that illustrated in FIGS. 1A, 1B, and 2.

### DETAILED DESCRIPTION OF THE EMBODIMENTS

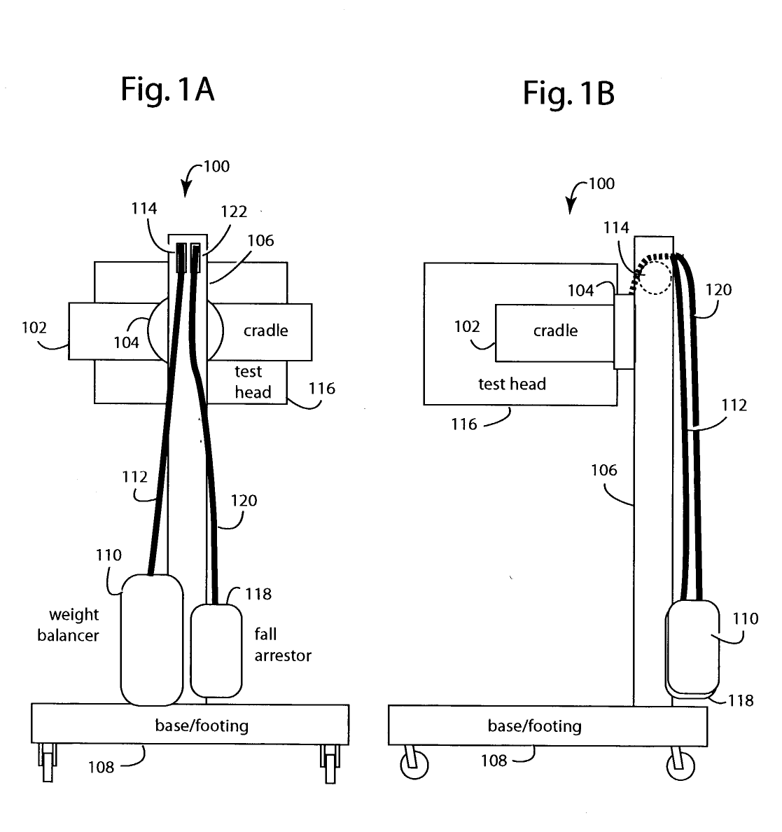

FIGS. 1A and 1B illustrate a test manipulator embodiment of the present invention, and is referred to herein by the general reference numeral 100. The test manipulator 100 comprises a cradle assembly 102 that is attached by a vertical slider 104 to a support column 106 on a base/footing 108. A weight balancer 110 is attached to the base/footing 108 and has a tension cable 112 that threads over a first top pulley 114 and down to the vertical slider 104. The weight balancer 110 is set to counterbalance the weight of the cradle assembly 102 and a test-head 116. A fall arrestor 118 is also attached to the base/footing 108 and has a self-retracting cable 120 that threads over a second top pulley 122 and down to the vertical slider 104. The fall arrestor 118 includes a sensor that will brake its cable 120 to prevent a free-fall of the cradle assembly 102 and test-head 116.

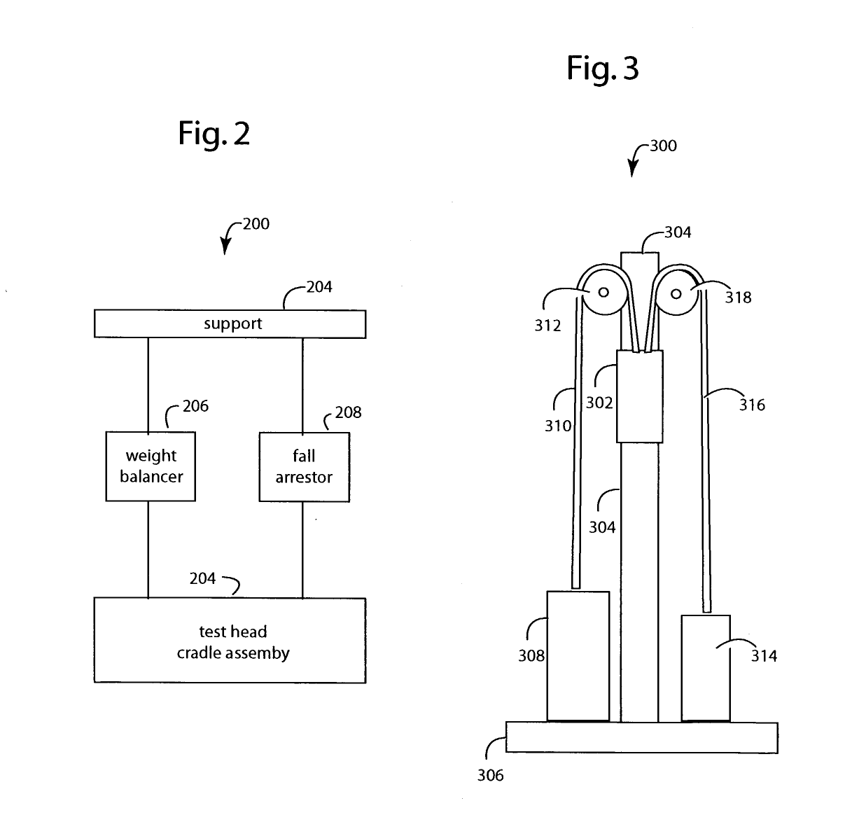

FIG. 2 is a schematic diagram of a simplified test manipulator embodiment of the present invention, and is referred to herein by the general reference numeral 200. A test head cradle assembly 202 is suspended from a support 204 by a weight balancer 206. The test head cradle assembly 202 is prevented from falling by a fall arrestor 208 that is in parallel to the weight balancer 206.

FIG. 3 illustrates a drop-preventing load balancer embodiment of the present invention, and is referred to herein by the general reference numeral 300. The drop-preventing load balancer 300 comprises a slider assembly 302 for levitating a heavy workpiece. The slider assembly 302 is free to move vertically on a support column 304 mounted to a base/footing 306. A weight balancer 308 is attached to the base/footing 306 and has a tension cable 310 that threads over a first top pulley 312 and down to the vertical slider 302. The weight balancer 308 is set to counterbalance the weight of the slider assembly 302 and any workpiece load it is levitating. A fall arrestor 314 is also attached to the base/footing 306 and has a self-retracting cable 316 that threads over a second top pulley 318 and down to the vertical slider 302. The fall arrestor 314 will brake its cable 316 to prevent a free-fall of the slider assembly 302.

Embodiments of the present invention all comprise two basic active components, a tool balancer to weightlessly suspend the test head, and a separately connected fall arrestor to automatically brake any free-fall of the test head. The commercial market has demonstrated the variety of ways that tool balancing, load balancing, and weight balancing products can be implemented. Counter-weights connected by simple cables and pulley mechanisms were an early type used in this industry. Springs, especially coiled springs wound on reels and connected with cables are another way. Motor-assisted units are now being used in models that support the heaviest test-head loads. For example, the IN2PRO-TALON universal positioning system marketed by inTest (Cherry Hill, N.J.), see www.intest.com.

The fall arrestor, which is placed in parallel with the weight balancer, can be implemented in a variety of ways in embodiments of the present invention. Such fall arrestor should not add significant resistance to the up and down sliding of the cradle assembly during normal use. But it should act quickly and reliably to lock up and hold the cradle assembly from a rapid descent, e.g., when the tool balancer fails. If the fall arrestor used is of the cable type, it is preferable that the cable be self-retracting so that any slack is always taken up.

It is also very desirable for the fall arrestor to not be damaged, require rebuilding, or need replacing after having acted. These characteristics are all fully satisfied by the many commercially available fall arrestors that are common in the construction industry for worker safety. Such commercial products are intended to prevent people from being injured in a fall, and the users are required to wear full harnesses. Here, self-retracting cable inertia reel fall arrestors are adapted to a semiconductor equipment positioner and manipulator.

The fall arrestor, in embodiments of the present invention, preferably shares no weight supporting structural components with the weight balancer. The purpose of not sharing such is it further avoids a failure of both the weight balancer and the fall arrestor to control the cradle assembly and its load. The fall arrestor should therefore have its own attachments directly to the structural supports and the cradle assembly. So including a fall arrestor inside the weight balance would not be acceptable because both would share the same cable attached to the cradle assembly.

The fall arrestors shown in FIGS. 1A, 1B, and 2, all sense a cradle assembly load starting to fall by the velocity of the cable being withdrawn from the cable retractor. Alternatively, such sensing could be based on a significant slackening of load on the weight-balancer cable or a lightening at its top pulley.

The implementation of embodiments of the present invention may be assisted by referring to two United States patents in which overhead doors are safed against sudden falls due to a weight suspension system failure. W. H. Purcell describes a vertical lift door safety latch in U.S. Pat. No. 3,276,165, issued Oct. 4, 1966. Raymond Sauve describes a fall arrestor and lockdown device for vertical lift doors in U.S. Pat. No. 6,485,068 B1, issued Nov. 26, 2002. Both such patents are incorporated herein by reference.

The basic use and implementation of the cradle assembly, footing, slides, and vertical shafts or support columns are similar to that described by Nathan Smith in U.S. Pat. No. 4,588,346, issued May 13, 1986, and titled “Positioner For Maintaining An Object In A Substantially Weightless Condition”. And also see, U.S. Pat. No. 5,241,870, issued Sep. 7, 1993, to Alyn Holt, and titled “Test Head Manipulator”. Such patents are also incorporated herein by reference.

Commercially marketed tool balancers are preferably adapted for use in embodiments of the present invention, e.g., to keep manufacturing costs low and commercial market price points very competitive. For example, the Packers Kromer “zero gravity” tool balancer from Packers Engineering and Equipment Co., Inc (Omaha, Nebr.) www.packerskromer.com, and the balancers made by Aero-Motive Company, Inc., (Kalamazoo, Mich.) see, www.aero-motive.com. The later supplier describes their product as preventing premature failure by using a WEAR-GUARD coating on the drum and a four-roller guide to protect the cable and drum from excessive wear. Quick, easy tool changes are said to be possible with the manual drum lock. An automatic lock is included that secures load if tension drops. The LA Series of Aero-Motive balances have a containerized mainspring for safe, easy spring handling. Easy external adjustments require no special tools, e.g., for changing the load weight. A full range of motion is provided by a 360° swivel hanger. A declutching hub is included to prevent spring damage, even when the spring is reverse wound.

Commercially marketed load arrestors can be used to reduce manufacturing costs and sales prices, and these are preferably adapted for use in embodiments of the present invention. For example, the Tri-Motion DROP-STOP load arrestors from Tri-Motion Industries, Inc. (Tampa, Fla.) see www.trimotionindustries.com, and also the model 3700300 personal fall arrest product from DBI/SALA (Red Wing, Mich.). Such load arrestor is described by DBI/SALA as having a models with maximum loads of 660 to 6,600 pounds and cable lengths of 8-99 feet. These are based on an inertia activated brake that includes a brake indicator button ad shock absorbing system. Advertised uses include the protection of valuable equipment and materials with self-contained backup load arrestors that are able to completely stop a dropping load if it breaks free from a main support.

A method embodiment of the present invention for manipulating a weight comprises the steps of counter-balancing a weight with a tool balancer, and preventing a sudden drop of the weight with a fall arrestor. The overall manufacturing costs can be reduced in a preliminary step to gain a competitive price-point advantage by using a self-contained commercially marketed tool balancer unit for the step of counter-balancing. Similarly, the overall manufacturing costs can also be reduced to gain a competitive price-point advantage by using a self-contained commercially marketed fall arrestor unit for the step of preventing a sudden drop.

In another method embodiment of the present invention for manipulating a weight, the method comprises the steps of supporting a weight above a work floor with a vertical slide, counter-balancing the weight with a tool balancer, and preventing a sudden drop of the weight with a fall arrestor. A method for manipulating a test head comprises the steps of supporting a test-head cradle assembly above a work floor with a vertical slide, counter-balancing the weight of the test-head cradle assembly with a tool balancer, and preventing a sudden drop of the test-head cradle assembly with a fall arrestor.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A test-head manipulator, comprising:
a cradle assembly for supporting a test head;
a weight balancer connected to support the cradle assembly and providing for a counter balance to the combined weight of the cradle assembly and said test head; and
a fall arrestor independently connected to the cradle assembly and providing for the stopping of a fall of the cradle assembly and said test head.

2. The test-head manipulator of claim 1, further comprising:
a vertical column support on which the cradle assembly is attached and is able to move vertically; and
a set of pulleys attached to the top of the vertical column support and providing for independent cable attachment of each of the weight balancer and fall arrestor to the cradle assembly.

3. The test-head manipulator of claim 1, wherein:
the weight balancer is a discrete subassembly sold as a complete unit on the commercial market.

4. The test-head manipulator of claim 1, wherein:
the fall arrestor is a discrete subassembly sold as a complete unit on the commercial market.

5. A method for manipulating a weight, the method comprising the steps of:
counter-balancing a weight with a tool balancer;
preventing a sudden drop of said weight with a fall arrestor.

6. The method of claim 5, further comprising the preliminary step of:
reducing overall manufacturing costs to gain a competitive price-point advantage by using a self-contained commercially marketed tool balancer unit for the step of counter-balancing.

7. The method of claim 5, further comprising the preliminary step of:
reducing overall manufacturing costs to gain a competitive price-point advantage by using a self-contained commercially marketed fall arrestor unit for the step of preventing a sudden drop.

8. A method for manipulating a weight, the method comprising the steps of:
supporting a weight above a work floor with a vertical slide;
counter-balancing said weight with a tool balancer;
preventing a sudden drop of said weight with a fall arrestor.

9. A method for manipulating a test head, the method comprising the steps of:
supporting a test-head cradle assembly above a work floor with a vertical slide;
counter-balancing the weight of said test-head cradle assembly with a tool balancer; and
preventing a sudden drop of said test-head cradle assembly with a fall arrestor.
